(19) United States
(12) Patent Application Publication
(10) Pub. No.: US 2024/0176523 A1
(43) Pub. Date: May 30, 2024

(54) TECHNIQUES FOR COUPLED HOST AND MEMORY DIES

(71) Applicant: Micron Technology, Inc., Boise, ID (US)

(72) Inventors: James Brian Johnson, Boise, ID (US); Brent Keeth, Boise, ID (US); Kunal R. Parekh, Boise, ID (US); Eiichi Nakano, Boise, ID (US); Amy Rae Griffin, Boise, ID (US); Ameen D. Akel, Rancho Cordova, CA (US)

(21) Appl. No.: 18/516,734

(22) Filed: Nov. 21, 2023

Related U.S. Application Data
(60) Provisional application No. 63/428,412, filed on Nov. 28, 2022.

(51) Int. Cl. G06F 3/06; G06F 1/06

(52) U.S. Cl. CPC G06F 3/064; G06F 1/06; G06F 3/061; G06F 3/0683

(57) ABSTRACT

Methods, systems, and devices for techniques for coupled host and memory dies are described. For example, to distribute memory access circuitry among multiple semiconductor dies of a stack, a first die may include a set of one or more memory arrays and a first portion of the circuitry configured to access the set of memory arrays, and a second die may include a second portion of the circuitry configured to access the set of memory arrays. The first portion and the second portion of the circuitry configured to access a set of memory arrays may be communicatively coupled between the dies using various interconnection techniques, such as a fusion of conductive contacts of the respective memory dies. In some examples, the second die may also include the host itself (e.g., a host processor).

### CROSS REFERENCE

The present Application for Patent claims the benefit of and priority to U.S. Provisional Patent Application No. 63/428,412 by Johnson et al., entitled “TECHNIQUES FOR COUPLED HOST AND MEMORY DIES,” filed Nov. 28, 2022, which is assigned to the assignee hereof, and which is expressly incorporated by reference in its entirety herein.

### TECHNICAL FIELD

The following relates to one or more systems for memory, including techniques for coupled host and memory dies.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 illustrates an example of a system that supports techniques for coupled host and memory dies in accordance with examples as disclosed herein.

FIG. 2 illustrates an example of a system that supports techniques for coupled host and memory dies in accordance with examples as disclosed herein.

FIG. 3 illustrates an example of an interface architecture that support techniques for coupled host and memory dies in accordance with examples as disclosed herein.

FIGS. 4 and 5 illustrate flowcharts showing methods that support techniques for coupled host and memory dies in accordance with examples as disclosed herein.

### DETAILED DESCRIPTION

In some memory systems, a memory die may include one or more memory arrays (e.g., one or more arrays of memory cells) and control circuitry configured for accessing the one or more memory arrays (e.g., in response to an access command). Such a memory die may include contacts, such as solder pads, that support a communicative coupling between the control circuitry of the memory die and a host (e.g., a host device) that issues commands to access the one or more memory arrays. However, some interconnection techniques for such memory dies may have limitations associated with a quantity of contacts supported for a given die size (e.g., contact density limitations), or a throughput of information between the control circuitry and a host (e.g., data rate limitations), or an amount of storage for a given die size (e.g., storage density limitations), among other issues.

In accordance with examples as disclosed herein, a semiconductor system, such as a memory system, may distribute memory access circuitry among multiple semiconductor dies of a stack. For example, a first die may include one or more memory arrays and a first portion of the circuitry configured to access the one or more memory arrays (e.g., a first interface block), and a second die may include a second portion of the circuitry configured to access the one or more memory arrays (e.g., a second interface block). In some examples, the first portion of the access circuitry (e.g., of the first die) may include array decoder circuitry, writing and sensing circuitry, timing circuitry, or synchronization and sequencing logic for accessing the memory arrays, or any combination thereof, whereas the second portion of the access circuitry (e.g., of the second die) may include circuitry to support access operation configurations, repair, interface training, error control (e.g., error detection, error correction), temperature adaptation, adverse access pattern mitigation, or self-test functionality for accessing the memory arrays, or any combination thereof. However, various examples of the described techniques may include other distribution of memory access functionality among circuitry of multiple semiconductor dies.

The first portion and the second portion of the circuitry configured to access a set of memory arrays may be communicatively coupled between the dies using one or more of various interconnection techniques, such as a fusion of conductive contacts of the respective memory dies, which may enable a relatively higher density of contacts than other techniques. In some examples, the second die may also include the host itself (e.g., a host processor), which may further reduce limitations associated with memory die interconnections. Such an architecture may be extended by including multiple sets of memory arrays on a given first die, each with a respective first portion of the access circuitry, or by stacking a set of multiple first dies over a given second die, or both, such that the second die includes a respective second portion of the access circuitry for each set of memory arrays of the one or more first dies in the stack. By dividing memory access circuitry among multiple semiconductor dies in accordance with one or more of the described techniques, a memory system may be configured with an increased throughput of information, or a greater storage density, among other advantages, compared with other techniques for configuring a memory system.

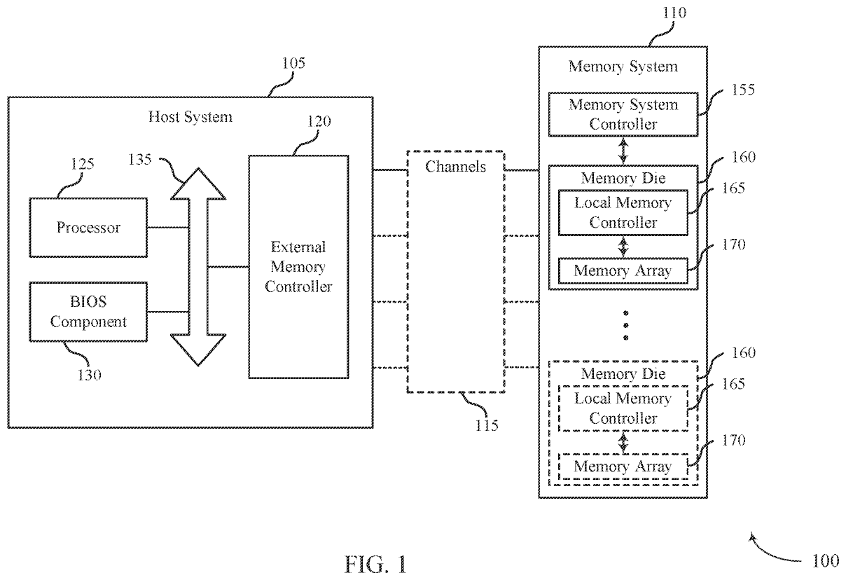

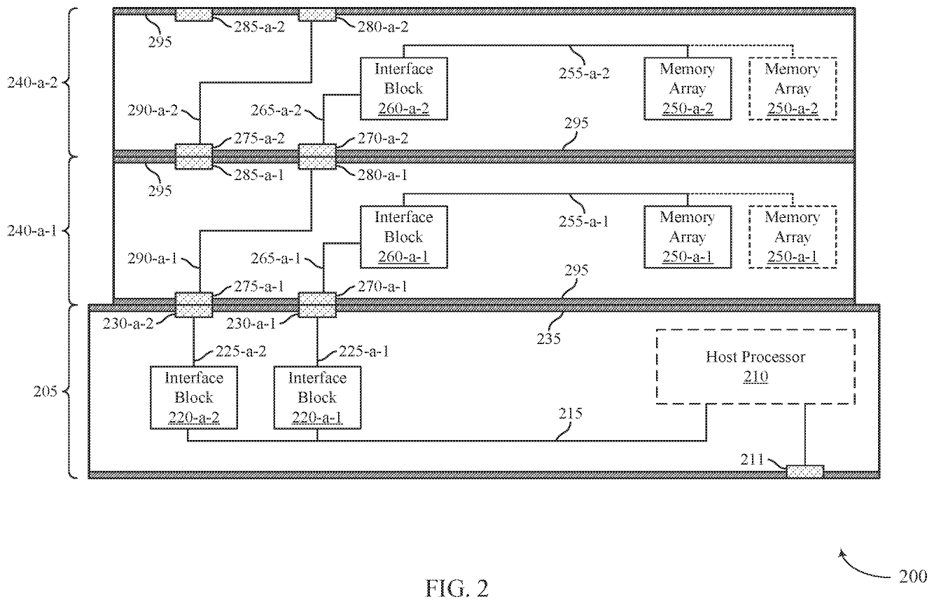

Features of the disclosure are initially illustrated and described in the context of systems with reference to FIG. 1. Features of the disclosure are illustrated and described in the context of a system, an interface architecture, and flowcharts with reference to FIGS. 2 through 5.

FIG. 1 illustrates an example of a system 100 that supports techniques for coupled host and memory dies in accordance with examples as disclosed herein. The system 100 may include portions of an electronic device, such as a computing device, a mobile computing device, a wireless communications device, a graphics processing device, a vehicle, or other systems. The system 100 includes a host system 105, a memory system 110, and one or more channels 115 coupling the host system 105 with the memory system 110 (e.g., to provide a communicative coupling). The system 100 may include one or more memory systems 110, but aspects of the one or more memory systems 110 may be described in the context of a single memory system 110.

The host system 105 may be an example of a processor (e.g., circuitry, processing circuitry, a processing component) that uses memory to execute processes, such as a processing system of a computing device, a mobile computing device, a wireless communications device, a graphics processing device, a wearable device, an internet-connected device, a vehicle controller, a system on a chip (SoC), or other stationary or portable electronic device, among other examples. The host system 105 may include one or more of an external memory controller 120, a processor 125, a basic input/output system (BIOS) component 130, or other components (e.g., a peripheral component, an input/output controller, not shown). The components of the host system 105 may be coupled with one another using a bus 135.

An external memory controller 120 may be configured to enable communication of information (e.g., data, commands, control information, configuration information) between components of the system 100 (e.g., between components of the host system 105, such as the processor 125, and the memory system 110). An external memory controller 120 may process (e.g., convert, translate) communications exchanged between the host system 105 and the memory system 110. In some examples, an external memory controller 120, or other component of the system 100, or associated functions described herein, may be implemented by or be part of the processor 125. For example, an external memory controller 120 may be hardware, firmware, or software (e.g., instructions), or some combination thereof implemented by a processor 125 or other component of the system 100 or the host system 105. Although an external memory controller 120 is illustrated outside the memory system 110, in some examples, an external memory controller 120, or its functions described herein, may be implemented by one or more components of a memory system 110 (e.g., a memory system controller 155, a local memory controller 165) or vice versa. In various examples, the host system 105 or an external memory controller 120 may be referred to as a host.

A processor 125 may be operable to provide functionality (e.g., control functionality) for the system 100 or the host system 105. A processor 125 may be a general-purpose processor, a digital signal processor (DSP), an application-specific integrated circuit (ASIC), a field-programmable gate array (FPGA) or other programmable logic device, discrete gate or transistor logic, discrete hardware components, or any combination thereof. In some examples, a processor 125 may be an example of a central processing unit (CPU), a graphics processing unit (GPU), a general purpose GPU (GPGPU), or an SoC, among other examples.

In some examples, the system 100 or the host system 105 may include an input component, an output component, or a combination thereof. Input components may include a sensor, a microphone, a keyboard, another processor (e.g., on a printed circuit board), an interface (e.g., a user interface, an interface between other devices), or a peripheral that interfaces with system 100 via one or more peripheral components, among other examples. Output components may include a display, audio speakers, a printing device, another processor on a printed circuit board, or a peripheral that interfaces with the system 100 via one or more peripheral components, among other examples.

The memory system 110 may be a component of the system 100 that is operable to provide physical memory locations (e.g., addresses) that may be used or referenced by the system 100. The memory system 110 may include a memory system controller 155 and one or more memory dies 160 (e.g., memory chips) to support a capacity for data storage. The memory system 110 may be configurable to work with one or more different types of host systems 105, and may respond to and execute commands provided by the host system 105 (e.g., via an external memory controller 120). For example, the memory system 110 (e.g., a memory system controller 155) may receive a write command indicating that the memory system 110 is to store data received from the host system 105, or receive a read command indicating that the memory system 110 is to provide data stored in a memory die 160 to the host system 105, or receive a refresh command indicating that the memory system 110 is to refresh data stored in a memory die 160, among other types of commands and operations.

A memory system controller 155 may include components (e.g., circuitry, logic) operable to control operations of the memory system 110. A memory system controller 155 may include hardware, firmware, or instructions that enable the memory system 110 to perform various operations, and may be operable to receive, transmit, or execute commands, data, or control information related to operations of the memory system 110. A memory system controller 155 may be operable to communicate with one or more of an external memory controller 120, one or more memory dies 160, or a processor 125. In some examples, a memory system controller 155 may control operations of the memory system 110 in cooperation with a local memory controller 165 of a memory die 160.

Each memory die 160 may include a local memory controller 165 and a memory array 170. A memory array 170 may be a collection of memory cells, with each memory cell being operable to store one or more bits of data. A memory die 160 may include a two-dimensional (2D) array of memory cells, or a three-dimensional (3D) array of memory cells. In some examples, a 2D memory die 160 may include a single memory array 170. In some examples, a 3D memory die 160 may include two or more memory arrays 170, which may be stacked or positioned beside one another (e.g., relative to a substrate).

A local memory controller 165 may include components (e.g., circuitry, logic) operable to control operations of a memory die 160. In some examples, a local memory controller 165 may be operable to communicate (e.g., receive or transmit data or commands or both) with a memory system controller 155. In some examples, a memory system 110 may not include a memory system controller 155, and a local memory controller 165 or an external memory controller 120 may perform various functions described herein. As such, a local memory controller 165 may be operable to communicate with a memory system controller 155, with other local memory controllers 165, or directly with an external memory controller 120, or a processor 125, or any combination thereof. Examples of components that may be included in a memory system controller 155 or a local memory controller 165 or both may include receivers for receiving signals (e.g., from the external memory controller 120), transmitters for transmitting signals (e.g., to the external memory controller 120), decoders for decoding or demodulating received signals, encoders for encoding or modulating signals to be transmitted, sense components for sensing states of memory cells of a memory array 170, write components for writing states to memory cells of a memory array 170, or various other components operable for supporting described operations of a memory system 110.

A host system 105 (e.g., an external memory controller 120) and a memory system 110 (e.g., a memory system controller 155) may communicate information (e.g., data, commands, control information, configuration information) using one or more channels 115. Each channel 115 may be an example of a transmission medium that carries information, and each channel 115 may include one or more signal paths (e.g., a transmission medium, an electrical conductor, an electrically conductive path) between terminals associated with the components of the system 100. For example, a channel 115 may be associated with a first terminal (e.g., including one or more pins, including one or more pads) at the host system 105 and a second terminal at the memory system 110. A terminal may be an example of a conductive input or output point of a device of the system 100, and a terminal may be operable to act as part of a channel 115.

In some examples, a channel 115 (e.g., associated signal paths and terminals) may be dedicated to communicating one or more types of information. For example, the channels 115 may include one or more command and address channels, one or more clock signal channels, one or more data channels, among other channels or combinations thereof. In some examples, signaling may be communicated over the channels 115 using single data rate (SDR) signaling or double data rate (DDR) signaling. In SDR signaling, one modulation symbol (e.g., signal level) of a signal may be registered for each clock cycle (e.g., on a rising or falling edge of a clock signal). In DDR signaling, two modulation symbols of a signal may be registered for each clock cycle (e.g., on both a rising edge and a falling edge of a clock signal).

In some implementations, interconnection techniques for memory dies 160 may have limitations associated with a quantity of contacts supported for a given die size (e.g., contact density limitations), or a throughput of information between the control circuitry and a host (e.g., data rate limitations), or an amount of storage for a given die size (e.g., storage density limitations), among other limitations. In accordance with examples as disclosed herein, circuitry for accessing one or more memory arrays 170 may be distributed among multiple semiconductor dies of a stack. For example, a first die may include a set of one or more memory arrays 170 and a first portion of the circuitry configured to access the set of memory arrays 170 (e.g., a first interface block), and a second die may include a second portion of the circuitry configured to access the set of memory arrays 170 (e.g., a second interface block). In some examples, the second die may also include the host itself (e.g., a host system 105, an external memory controller 120, a processor 125). Such an architecture may be extended by including multiple sets of memory arrays 170 on a given first die, each with a respective first portion of the access circuitry, or by stacking a set of multiple first dies over a given second die, or both, such that the second die includes a respective second portion of the access circuitry for each set of memory arrays of the one or more first dies in the stack. By dividing memory access circuitry among multiple semiconductor dies in accordance with one or more of the described techniques, a memory system may be configured with an increased throughput of information, or a greater storage density, among other advantages, compared with other techniques for configuring a memory system.

FIG. 2 illustrates an example of a system 200 (e.g., a semiconductor system, a system of coupled semiconductor dies) that supports techniques for coupled host and memory dies in accordance with examples as disclosed herein. The system 200 illustrates an example of a die 205 (e.g., a semiconductor die, a host die, a processor die) that is coupled with one or more dies 240 (e.g., dies 240-a-1 and 240-a-2, semiconductor dies, memory dies). A die 205 or a die 240 may be formed using a respective semiconductor substrate (e.g., silicon, germanium, silicon-germanium alloy, gallium arsenide, gallium nitride), such as a semiconductor wafer (e.g., a wafer of crystalline semiconductor), or a silicon-on-insulator (SOI) substrate (e.g., silicon-on-glass, (SOG), silicon-on-sapphire (SOP)), or epitaxial semiconductor materials formed on another substrate, among other examples. Although the illustrated example of a system 200 includes two dies 240, a system 200 in accordance with the described techniques may include any quantity of one or more dies 240 coupled with a die 205.

The system 200 illustrates an example of interface circuitry between a host and memory that is implemented in (e.g., divided between) multiple semiconductor dies. For example, the die 205 may include a set of one or more interface blocks 220 (e.g., interface blocks 220-a-1 and 220-a-1, memory interface blocks), and each die 240 may include a set of one or more interface blocks 260 and one or more memory arrays 250 (e.g., die 240-a-1 including an interface block 260-a-1 coupled with a set of one or more memory arrays 260-a-1, die 240-a-2 including an interface block 260-a-2 coupled with a set of one or more memory arrays 260-a-2). In some implementations, the die 205 also may include a host processor 210. However, in some other implementations, a host processor 210 may be external to a die 205, such as in another semiconductor die that is coupled with the die 205 (e.g., communicatively coupled with, directly coupled with via one or more contacts 211). Although the example of system 200 is illustrated with one interface block 260 included in each die 240, a die 240 in accordance with the described techniques may include any quantity of one or more interface blocks 260, each coupled with a respective set of one or more memory arrays 250, and each coupled with a respective interface block 220 of a die 205. Thus, the interface circuitry of a system 200 may include one or more interface blocks 220 of a die 205, with each interface block 220 being coupled with (e.g., in communication with) a corresponding interface block 260 of a die 240 (e.g., external to the die 205).

The host processor 210 may be an example of a host system 105, or a portion thereof (e.g., a processor 125, an external memory controller 120, or both). The host processor 210 may be configured to perform operations that implement storage of the memory arrays 250. For example, the host processor 210 may receive data read from the memory arrays 250, or transmit data to be written the memory arrays 250, or both (e.g., in accordance with an application or other operations of the host processor 210). The memory arrays 250 may be examples of memory arrays 170, and may include memory cells of various architectures, such as RAM. DRAM, SDRAM, SRAM, FeRAM, MRAM. RRAM, PCM, chalcogenide, NOR, or NAND memory cells, or any combination thereof. The host processor 210 may be configured to communicate (e.g., transmit, receive) signaling with the interface blocks 220 over a bus 215, which may implement aspects of channels 115 described with reference to FIG. 1. For example, the host processor 210 may be configured to transmit access signaling (e.g., control signaling, access command signaling), which may be received by the interface blocks 220 to support access operations (e.g., read operation, write operations) on the memory arrays 250.

A bus 215 may include a respective set of one or more signal paths for each interface block 220, such that the host processor 210 communicates with each interface block 220 over the respective set of signal paths (e.g., in accordance with a selection of the respective set to perform access operations via an interface block 220 that is selected by the host processor 210). Additionally, or alternatively, a bus 215 may include one or more signal paths that are shared among multiple interface blocks 220, and an interface block 220, or a host processor 210, or both may interpret, ignore, respond to, or inhibit response to signaling over shared signal paths of the bus 215 based on a logical indication (e.g., an addressing indication associated with the interface block 220 or an interface enable signal, which may be provided by the host processor 210 or the corresponding interface block 220, depending on signaling direction).

Each interface block 220 may be coupled with at least a respective bus 225 of the die 205, and a respective bus 265 of a die 240, that is configured to communicate signaling with the corresponding interface block 260 (e.g., over one or more associated signal paths). For example, the interface block 220-a-1 may be coupled with the interface block 260-a-1 via a bus 225-a-1 and a bus 265-a-1, and the interface block 220-a-2 may be coupled with the interface block 260-a-2 via a bus 225-a-2 and a bus 265-a-2. In some examples, a die 240 may include a bus that bypasses operational circuitry of the die 240 (e.g., bypasses interface blocks 260 of a given die 240), such as a bus 290. For example, the interface block 220-a-2 may be coupled with the interface block 260-a-2 of the die 240-a-2 via a bus 290-a-1 of the die 240-a-1, which may bypass interface blocks 260 of the die 240-a-1. Such techniques may be extended for interconnection among more than two dies 240 (e.g., for interconnection via a respective bus 290 of multiple dies 240).

The respective signal paths of the buses 225, 265, and 290 may be coupled with one another, from one die to another, via various arrangements of contacts at the surfaces of interfacing dies. For example, the bus 225-a-1 may be coupled with the bus 265-a-1 via a contact 230-a-1 of (e.g., at a surface of) the die 205 and a contact 270-a-1 of the die 240-a-1, the bus 225-a-2 may be coupled with the bus 290-a-1 via a contact 230-a-2 of the die 205 and a contact 275-a-1 of the die 240-a-1, the bus 290-a-1 may be coupled with the bus 265-a-2 via a contact 280-a-1 of the die 240-a-1 and a contact 270-a-2 of the die 240-a-2, and so on. Although each respective bus is illustrated with a single line, coupled via singular contacts, it is to be understood that each signal path of a bus may be associated with respective contacts to support a separate communicative coupling via each signal path of a given bus. In some examples, a bus 290 may traverse a portion of a die 240 (e.g., in an in-plane direction, along a direction different than a thickness direction, in a waterfall arrangement), which may support an arrangement of contacts 230 along a surface of the die 205 being coupled with interface blocks 260 of different dies 240 along a stack direction (e.g., via contacts 275 and 280 that are non-overlapping when viewed along a thickness direction).

The interconnection of interfacing contacts may be supported by various techniques. For example, in a hybrid bonding implementation, interfacing contacts may be coupled by a fusion of conductive materials of the interfacing contacts (e.g., without solder or other intervening material between contacts). For example, in an assembled condition, the coupling of the die 205 with the die 240-a-1 may include a conductive material of the contact 230-a-2 being fused with a conductive material of the contact 275-a-1, and the coupling of the die 240-a-1 with the die 240-a-2 may include a conductive material of the contact 280-a-1 being fused with a conductive material of the contact 270-a-2, and so on. In some examples, such coupling may include an inoperative fusion of contacts, such as a fusion of the contact 285-a-1 with the contact 275-a-2, neither of which are coupled with operative circuitry of the dies 240-a-1 or 240-a-2. In some examples, such techniques may be implemented to improve coupling strength or uniformity (e.g., implementing contacts 285, which may not be operatively coupled with an interface block 260 or an interface block 220), or such a coupling may be a byproduct of a repetition of components that, in various configurations, may be operative or inoperative. (e.g., where, for dies 240 with a common arrangement of contacts 275 and 285, contacts 275-a-1 and 280-a-1 provide a communicative path for the interface block 260-a-2 and the interface block 220-a-2, but the contacts 275-a-2 and 280-a-2 do not provide a communicative path between an interface block 260 and an interface block 220).

In some examples, a fusion of conductive materials between dies (e.g., between contacts) may be accompanied by a fusion of other materials at one or more surfaces of the interfacing dies. For example, in an assembled condition, the coupling of the die 205 with the die 240-a-1 may include a dielectric material 235 of the die 205 being fused with a dielectric material 295 of the die 240-a-1, and the coupling of the die 240-a-1 with the die 240-a-2 may include a dielectric material 295 of the die 240-a-1 being fused with a dielectric material 295 of the die 240-a-2. In some examples, such dielectric materials may include an oxide, a nitride, or an oxide-nitride combination of a semiconductor material of the die 205 or dies 240, among other materials that may support such fusion. However, coupling among dies 205 and dies 240 may be implemented in accordance with other techniques, which may implement solder, adhesives, thermal interface materials, and other intervening materials.

In some examples, dies 240 may be coupled in a stack (e.g., forming a “cube” or other arrangement of dies 240), and the stack may subsequently be coupled with a die 205. In some examples, a respective set of one or more dies 240 may be coupled with each die 205 of multiple dies 205 formed in a wafer (e.g., in a chip-to-wafer bonding arrangement, before cutting the wafer of dies 205), and the dies 205, coupled with their respective set of dies 240, may be separated from one another (e.g., by cutting at least the wafer of dies 205). In some other examples, a respective set of one or more dies 240 may be coupled with a respective die 205 after the die 205 is separated from a wafer of dies 205 (e.g., in a chip-to-chip bonding arrangement).

The buses 225, 265, and 290 may be configured to provide a configured signaling (e.g., a coordinated signaling, a logical signaling, modulated signaling, digital signaling) between an interface block 220 and a corresponding interface block 260, which may involve various modulation or encoding techniques by a transmitting interface block (e.g., via a driver component of the transmitting interface block). In some examples, such signaling may be supported by (e.g., accompanied by) clock signaling communicated via the respective buses (e.g., in coordination with signal transmission). For example, the buses may be configured to convey one or more clock signals transmitted by the interface block 220 for reception by the interface block 260 (e.g., to trigger signal reception by a latch or other reception component of the interface block 260, to support clocked operations of the interface block 260). Additionally, or alternatively, the buses may be configured to convey one or more clock signals transmitted by the interface block 260 for reception by the interface block 220 (e.g., to trigger signal reception by a latch or other reception component of the interface block 220, to support clocked operations of the interface block 220). Such clock signals may be associated with the communication (e.g., unidirectional communication, bidirectional communication) of various, such as control signaling, command signaling, data signaling, or any combination thereof. For example, the buses may include one or more signal paths for communications of a data bus (e.g., a DQ bus, via a data interface of the interface blocks) in accordance with one or more corresponding clock signals (e.g., data clock signals), or one or more signal paths for communications of a control bus (e.g., a command/address (C/A) bus, via a command interface of the interface blocks) in accordance with one or more clock signals (e.g., control clock signals), or any combination thereof.

Interface blocks 220 and 260 each may include circuitry in various configurations (e.g., hardware configurations, logic configurations, software or instruction configurations) that support the functionality allocated to the respective interface block for accessing a corresponding set of memory arrays 250. For example, interface blocks 220 may include circuitry configured to perform a first subset of operations that support access of the memory arrays 250, and interface blocks 260 may include circuitry configured to support a second subset of operations that support access of the memory arrays 250. In some examples, the interface blocks 220 and 260 may support a functional split or distribution of functionality associated with a memory system controller 155, a local memory controller 165, or both across multiple dies (e.g., a die 205 and at least one die 240). Such subsets of operations may include operations performed in response to commands from the host processor 210, or operations performed without commands from the host processor 210 (e.g., operations determined within an interface block 220 or within an interface block 260), or various combinations thereof. The circuitry of interface blocks 220 and 260 may include components (e.g., transistors) formed at least in part from doped portions of a substrate of the respective die where, in some examples, a substrate of a die 205 may have characteristics that are different than those substrate of a die 240.

In some examples, the interface blocks 220 may include circuitry configured to receive first access command signaling from the host processor 210 (e.g., via a bus 215, via one or more contacts 211, where applicable), and to transmit second access command signaling to the respective (e.g., coupled) interface block 260 based on (e.g., in response to) the received first access command signaling. The interface blocks 260 may accordingly include circuitry configured to receive the second access command signaling from the respective interface block 220, and to access a respective set of one or more memory arrays 250 based on (e.g., in response to) the received second access command signaling. In various examples, the first access command signaling may include access commands that are associated with a type of operation (e.g., a read operation, a write operation, a refresh operation, a memory management operation), which may be associated with an indication of an address of the one or more memory arrays 250 (e.g., a logical address, a physical address) In some examples, the first access command signaling may include an indication of a logical address associated with the memory arrays 250, and circuitry of an interface block 220 may be configured to generate the second access command signaling to indicate a physical address associated with the memory arrays 250 (e.g., a row address, a column address, using a logical-to-physical (L2P) table or other mapping or calculation functionality of the interface block 220).

In some examples, to support write operations of the system 200, circuitry of the interface blocks 220 may be configured to receive (e.g., from the host processor 210, via a bus 215) first data signaling associated with the first access command signaling, and to transmit second data signaling (e.g., associated with second access command signaling) based on received first access command signaling and first data signaling. The interface blocks 260 may accordingly be configured to receive second data signaling, and to write data to one or more memory arrays 250 (e.g., in accordance with an indicated address associated with the first access command signaling) based on the received second access command signaling and second data signaling. In some examples, the interface blocks 220 may include an error control functionality (e.g., error detection circuitry, error correction circuitry, error correction code (ECC) logic, an ECC engine) that supports the interface blocks 220 generating the second data signaling based on performing an error control operation using the received first data signaling (e.g., detecting or correcting an error in the first data signaling, determining one or more parity bits to be conveyed in the second data signaling and written with the data).

In some examples, to support read operations of the system 200, circuitry of the interface blocks 260 may be configured to read data from the memory arrays 250 based on received second access command signaling, and to transmit first data signaling based at least in part on the read data. The interface blocks 220 may accordingly be configured to receive first data signaling, and to transmit second data signaling (e.g., to the host processor 210, via a bus 215) based on the received first data signaling. In some examples, the interface blocks 220 may include an error control functionality that supports the interface blocks 220 generating the second data signaling based on performing an error control operation using the received first data signaling (e.g., detecting or correcting an error in the first data signaling, which may include a calculation involving one or more parity bits received with the first data signaling).

In some examples, access command signaling that is transmitted by the interface blocks 220 to the interface blocks 260 may be generated (e.g., based on access command signaling received from a host processor 210, based on initiation signaling received from a host processor 210, without receiving or otherwise independent from signaling from a host processor 210) in accordance with various determination or generation techniques configured at the interface blocks 220 (e.g., based on a configuration for accessing memory arrays 250 that is modified at the interface blocks 220). Such techniques may support the interface blocks 220 configuring aspects of the access operations performed on the memory arrays 250 by a respective interface block 260.

In some examples, one or more interface blocks 220 may be configured to support a repair functionality for accessing memory arrays 250. For example, an interface block 220 may generate access command signaling based on a detected error associated with a physical address the memory arrays 250 (e.g., memory arrays 250 that are coupled with the respective interface block 260), which may include a remapping of address space (e.g., physical addresses) by the interface block 220 to avoid accessing the physical address associated with the detected error. In some examples, an interface block 220 may generate access command signaling to indicate a row address that avoids a physical address of a failed row, or to indicate a column address that avoids a physical address of a failed column, among other examples. A detected error may be associated with (e.g., may correspond to) failure or other inoperability of a row of memory cells, of a column of memory cells, or of a section of memory cells (e.g., a subarray) of a memory array 250, or of a memory array 250 among a set of multiple memory arrays 250, among other delineations of physical address space. In some examples, such an error may be detected by the interface block 220, or by an interface block 260 and signaled to the interface block 220, or by the host processor 210 and indicated to the interface block. In some examples, such an error may be detected in a manufacturing or validation operation, and an indication of the error may be stored in the system 200 in a manner accessible to the interface block 220 (e.g., in a register of or accessible to the interface block 220).

In some examples, one or more interface blocks 220 may be configured to support an interface training functionality. For example, an interface block 220 may be configured to synchronize, configure, or otherwise coordinate clock signal timing (e.g., frequency, phasing, offset) between the interface block 220 and the respective interface block 260. In some examples, such training may involve an interface block 220 transmitting first clock signaling to the respective interface block 260 and receiving second clock signaling or other signaling from the respective interface block 260 (e.g., based on transmitting the first clock signaling). Based on such transmitted and received signaling, the interface block 220 may modify a timing of the first clock signaling, or may transmit an indication to the respective interface block 260 to modify a timing of the second clock signaling, among other aspects of interface training.

In some examples, one or more interface blocks 220 may be configured to support mitigation of row hammer or other adverse access patterns. For example, an interface block 220 may be configured to determine (e.g., based on access command signaling received from the host processor 210) that a rate of accessing one or more physical addresses of the memory arrays 250 (e.g., memory arrays 250 coupled with the respective interface block 260) satisfies a threshold. Such an evaluation may include determining whether a particular row of memory cells, or other portion of a memory array 250, is being accessed with a rate that meets or exceeds a threshold. The interface block 220 may be configured to generate access command signaling based on such an evaluation, which may include reducing a rate of accessing a particular physical address (e.g., one or more rows of memory cells), or inhibiting access to a particular physical address (e.g., for a configured duration), among other access modifications by the interface block 220 relative to the access command signaling received from the host processor 210. Additionally, or alternatively, the interface block 220 may be configured to generate refresh operation signaling based on a rate of accessing one or more physical addresses satisfying a threshold (e.g., commanding refresh operations to rows in proximity of one or more hammered rows or regions that are otherwise accessed relatively frequently), where such refresh operation signaling may involve changing a rate or time of refresh, or performing refresh operations at different rates or times among memory arrays 250 or portions thereof that are coupled with the interface block 220, or performing refresh operations at different rates or times than another interface block 220, among other examples.

In some examples, one or more interface blocks 220 may be configured to support a refresh control functionality. For example, an interface block 220 may be configured to generate an access pattern (e.g., a pattern of addresses) for performing refresh operations, and generate access command signaling based on the access pattern generated by the interface block 220. Such an access pattern generation may include determining a rate for refreshing memory cells of the memory cells, or addresses for refreshing, among other refresh parameters, which may be applied to each memory array 250 coupled with the respective interface block 260, or specific to a certain one or more of such memory arrays 250. In various examples, an interface block 220 may be configured to determine a refresh rate, or other refresh parameter, based on signaling from a host processor 210, based on signaling from an interface block 260, or based on an evaluation of conditions by the interface block 220, or various combinations thereof (e.g., based on an indicated access pattern, based on an indicated operating condition such as temperature or voltage).

In some examples, one or more interface blocks 220 may be configured to support a temperature adaptation or mitigation functionality. For example, an interface block 220 may receive an indication of a temperature of the system 200 (e.g., an operating temperature, a temperature at which a component of the system 200 is operating), which may include an indication of a temperature itself (e.g., as an analog or digital input signal), or an indication of whether a temperature satisfies (e.g., is above, is below, is between) one or more thresholds, among other indications. Such an indication may be based on a temperature measured by a sensor outside the system 200, or coupled with (e.g., assembled with) the system 200, or embedded in the system 200 (e.g., as part of a die 205, as part of a die 240), or a combination thereof. The interface block 220 may generate access command signaling based on the temperature indication, which may include configuring a parameter for accessing a memory array 250 (e.g., a timing, an access rate, a reference voltage, a refresh rate) based on the temperature, selecting or avoiding a memory array 250 or portion thereof based on the temperature, inhibiting access operations based on the temperature, or implementing a temperature adjustment operation (e.g., a heating operation, a cooling operation), among other configurations or any combination thereof.

In some examples, one or more interface blocks 220 may be configured to support a self-test (e.g., a built-in self-test (BIST)) functionality. For example, an interface block 220 may be configured to generate an access pattern for evaluating various operations of a respective interface block 260, one or more memory arrays 250, or a combination thereof, and transmit access command signaling, data signaling, or both in accordance with the generated access pattern. In various examples, the interface block 220 may be configured to initiate such an evaluation based on signaling received from the host processor 210, or from the respective interface block 260, or a combination thereof. Additionally, or alternatively, the interface block 220 may be configured to initiate such an evaluation based on conditions detected at the interface block 220 (e.g., based on an error detection, based on determining that an operating condition satisfies a threshold). In response to such an evaluation, an interface block 220 may modify a configuration for operations with the respective interface block 260 or one or more memory arrays 250 (e.g., an operating parameter, an error control configuration, a repair configuration), or may transmit an indication of a result of the evaluation (e.g., to the respective interface block 260, to the host processor 210), among other responsive operations.

In some examples, one or more interface blocks 220 may be configured to support a timing or latency control functionality. For example, an interface block 220 may be configured to control a timing of operations performed by an interface block 260, which may refer to an absolute timing (e.g., relative to clock signaling from the host processor 210), or a timing that is relative to timing of another interface block 220, or both. For example, one or more interface blocks 220 may be configured to command operations via their respective interface block 260 with a timing that is offset (e.g., staggered) relative to operations commanded by one or more other interface blocks 220. In some examples, such a staggering may balance or otherwise distribute power consumption (e.g., may reduce a ratio of peak power to average power), which may improve operational uniformity (e.g., voltage regulation uniformity) for components of the system 200. In some examples, such techniques may be supported by one or more interface blocks 220 being configured to transmit first clock signaling to their respective interface block 260 (e.g., in accordance with a first timing), and one or more other interface blocks 220 being configured to transmit second clock signaling to their respective interface block 260 with a timing that is offset relative to the first clock signaling.

In some examples, one or more interface blocks 220 may be configured for other memory management techniques, which may be included as part of a reliability, availability, and serviceability (RAS) solution supported by the interface blocks 220. For example, a RAS solution configured at an interface block 220 may include supporting a channel data correction, such as a chip-kill or channel kill mechanism, which may involve ganging channels together to support channel-level correctability. Additionally, or alternatively, a RAS solution configured at an interface block 220 may include supporting a cyclic redundancy check (CRC) functionality, which may be implemented for command/address integrity or data integrity Additionally, or alternatively, a RAS solution configured at an interface block 220 may include supporting burn-in, scrubbing, test flow, qualification, or in-field BIST functionality.

Additionally, or alternatively, a RAS solution configured at an interface block 220 may include supporting a floor sweeping functionality. Floor sweeping may include an interface block 220 being configured to map out or map around regions of a die 240 (e.g., of an interface block 260, or a memory array 250) that are otherwise unrepairable. When mapping out or mapping around a region of a memory array 250, such regions can be as small as single row or column within a bank or channel, or may be successively larger regions, such as array sections, multiple array sections, banks, and even entire channels. In some implementations, a die 240 may be overprovisioned to allow for remapping so that elements in a dedicated region can be used for remapping within a channel or across channels to statically or dynamically replace failing regions of varying size. In some examples, such techniques may support improvements to overall product yield (e.g., yield of dies 240, yield of systems 200), even if such techniques may reduce an amount of overall memory capacity.

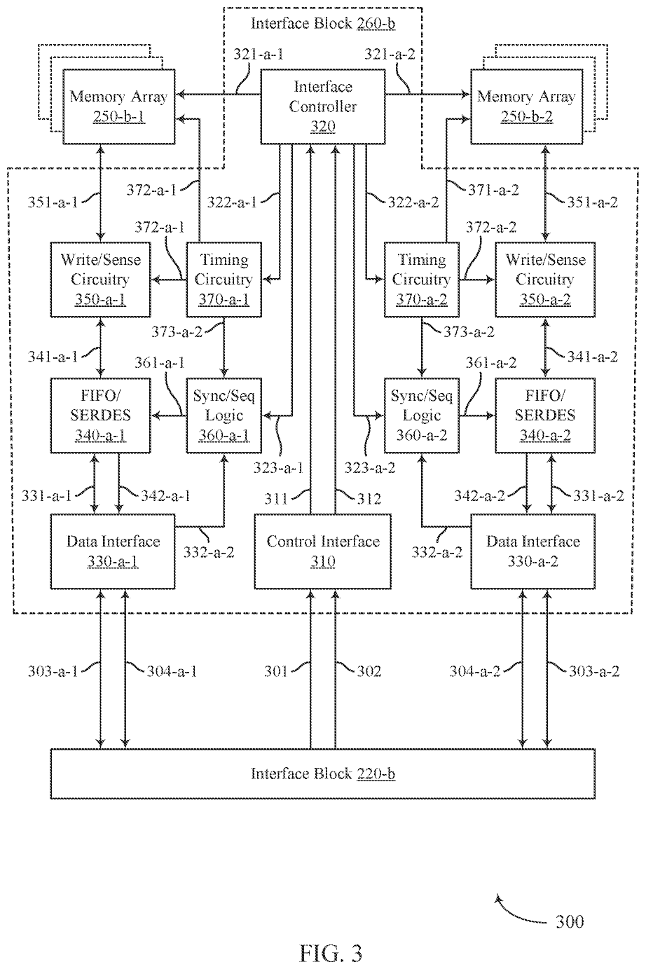

FIG. 3 illustrates an example of an interface architecture 300 that supports techniques for coupled host and memory dies in accordance with examples as disclosed herein. The interface architecture 300 illustrates an example of an interface block 260-b (e.g., of a die 240) coupled with an interface block 220-b (e.g., of a die 205). The interface block 260-b may be communicatively coupled with the interface block 220-b via one or more of a bus 301, a bus 302, a bus 303, and a bus 304, each of which may be examples of one or more signal paths of a bus 225 and a bus 265, as well as a bus 290, where applicable.

The interface block 260-b includes a control interface 310 (e.g., a command interface), which may be configured to communicate signaling with the interface block 220-b. For example, the control interface 310 may include circuitry (e.g., a receiver, one or more latches) configured to receive control signaling (e.g., modulated control signaling, access command signaling, configuration signaling, address signaling, such as row address signaling or column address signaling) over the bus 301. The control interface 310 also may include circuitry configured to receive clock signaling (e.g., clock signaling associated with the control interface 310, clock signaling having one or more phases, such as true and complement phases, dk_t/c signaling from the interface block 220-b) over the bus 302, which the control interface 310 may use for receiving the control signaling of the bus 301 (e.g., for triggering the one or more latches). The control interface 310 may transmit (e.g., forward) the control signaling over a bus 311, and may transmit the clock signaling over a bus 312 (e.g., for timing of other operations of the interface block 260-b), each of which may be received by an interface controller 320.

The interface block 260-b also includes two data interfaces 330 (e.g., data interfaces 330-a-1 and 330-a-2), which also may be configured to communicate signaling with the interface block 220-b. Each data interface 330 may include corresponding buses and circuitry, the operation of which may be associated with (e.g., controlled by, coordinated with, operated based on) control signaling via the control interface 310. Although the example of interface block 260-b includes two such data interfaces 330 associated with the control interface 310 (e.g., in a “channel pair” arrangement), the described techniques for an interface block 260 may include any quantity of one or more data interfaces 330, and associated buses and circuitry, for a given control interface 310 of the interface block 260. Each data interface 330 may be associated with respective data path circuitry, which may include respective first-in-first-out (FIFO) and serialization/deserialization (SERDES) circuitry (e.g., FIFO/SERDES 340), respective write/sense circuitry 350, respective synchronization and sequencing circuitry (e.g., sync/seq logic 360), and respective timing circuitry 370, along with interconnecting signal paths (e.g., one or more buses). However, in some other examples, data path circuitry may be arranged in a different manner, or may include different circuitry components, which may include circuitry that is dedicated to respective data paths, or shared among data paths, or various combinations thereof. Each data interface 330 also may be associated with a respective set of one or more memory arrays 250. In some examples, each memory array 250 may be understood to include respective addressing circuitry such as bank logic or decoders (e.g., a row decoder, a column decoder), among other array circuitry. However, in some other examples, at least a portion of such circuitry may be included in the interface block 260.

Each data interface 330 may include circuitry (e.g., one or more latches, one or more drivers) configured to communicate (e.g., receive, transmit) data signaling (e.g., modulated data signaling. DQ signaling) over a respective bus 303. Each data interface 330 also may include circuitry to communicate clock signaling over a respective bus 304, which may support clock signal reception by the data interface 330 (e.g., first clock signaling associated with the data interface 330, clock signaling having one or more phases, such as true and complement phases, DQS_t/c signaling from the interface block 220-b, clock signaling associated with data reception or write operations), or clock signal transmission by the data interface 330 (e.g., second clock signaling associated with the data interface 330. RDQS_t/c signaling to the interface block 220-b, clock signaling associated with data transmission or read operations), or both. Each data interface 330 may transmit clock signaling (e.g., received clock signaling. DQS_t/c signaling) over a respective bus 332 (e.g., for timing of other operations of the interface block 260-b).

The interface controller 320 may support various control or configuration functionality of the interface block 260-b for accessing or otherwise managing operations of the coupled memory arrays 520. For example, the interface controller 320 may support access command coordination or configuration, latency or timing compensation, access command buffering (e.g., in accordance with a first-in-first-out FIFO or other organizational scheme), mode registers or logic for configuration settings, or test functionality, among other functions or combinations thereof. For each data path of the interface block 260 (e.g., associated with a respective data interface 330), the interface controller 320 may be configured to transmit signaling to the respective memory arrays 250 over a bus 321 (e.g., address signaling, such as a row address or row activation signaling), to transmit signaling to the respective timing circuitry 370 over a bus 322 (e.g., timing signaling, which may be based on clock signaling received via the bus 312, configuration signaling), and to transmit signaling to the respective sync/seq logic 360 over a bus 323 (e.g., timing signaling, which may be based on clock signaling received via the bus 312, configuration signaling).

For each data path, the respective timing circuitry 370 may support timing of various operations (e.g., activations, coupling operations, signal latching, signal driving) relative to timing signaling received over a bus 322. For example, timing circuitry 370 may include a timing chain (e.g., a global column timing chain) configured to generate one or more clock signals or other initiation signals for controlling operations of the respective data path, and such signaling may include transitions (e.g., rising edge transitions, falling edge transitions, on/off transitions) that are offset from, at a different rate than, or otherwise different than transitions of signaling over the bus 322 to support a given operation or combination of operations. For example, timing circuitry 370 may be configured to transmit signaling to the respective memory arrays 250 over a bus 371 (e.g., column selection signaling, column address signaling), to transmit signaling to the respective write/sense circuitry 350 over a bus 372 (e.g., latch or driver timing signaling), and to transmit signaling to the respective sync/seq logic over a bus 373 (e.g., timing signaling).

For each data path, the respective FIFO/SERDES 340 may be configured to convert between data signaling of a first bus width (e.g., a relatively wide bus width, associated with a bus 341 (e.g., a data read/write (DRW) bus), having a relatively larger quantity of signal paths) and a second bus width (e.g., a relatively narrow bus width, associated with a bus 331, having a relatively smaller quantity of signal paths). In some examples, such a conversion may be accompanied by changing a rate of signaling between the bus 341 and the bus 331 (e.g., to maintain a given throughput). For example, a FIFO/SERDES 340 may support a conversion between the bus 341 having a bus width of 288 signal paths (e.g., for signaling Dat[287:0]) and the bus 331 having a bus width of 72 signal paths (e.g., for signaling DQ[71:0]), in which case a rate of signaling over the bus 331 may be four times as fast as a rate of signaling over the bus 341. In various examples, the FIFO/SERDES may receive data signaling over the bus 331 and transmit data signaling over the bus 341 (e.g., to support a write operation), or may receive data signaling over the bus 341 and transmit data signaling over the bus 331 (e.g., to support a read operation). In some examples (e.g., to support a read operation), the FIFO/SERDES 340 may be configured to transmit clock signaling (e.g., RDQS_t/c signaling) to the data interface 330, which may be forwarded to the interface block 220-b (e.g., over a bus 304, for reception of data signaling by the interface block 220-b received over a bus 331).

The timing or other synchronization of operations performed by the FIFO/SERDES 340 may be supported by one or more clock signals, among other signaling, received from the respective sync/seq logic 360 (e.g., over a bus 361). For example, the sync/seq logic 360 may generate or otherwise coordinate clock signaling to support the different rates of signaling of the bus 331 and the bus 341 (e.g., based on clock signaling received over a bus 332 and a bus 373). Additionally, or alternatively, the FIFO/SERDES 340 may operate in a direction (e.g., for data transmission to a data interface 330, for data reception from a data interface 330) or other mode based on configuration signaling received from the sync/seq logic 360.

For each data path, the respective write/sense circuitry 350 may be configured to support the accessing (e.g., data signaling, write signaling, read signaling) of the respective set of one or more memory arrays 250. For example, the write/sense circuitry 350 may be coupled with the memory arrays 250 over a bus 351 (e.g., a global input/output (GIO) bus), which may include respective signal paths associated with each memory array 250, or may include signal paths that are shared for all of the memory arrays 250 of the set, in which case the memory array circuitry may include multiplexing circuitry operable to couple the bus 351 with a selected one of the memory arrays 250. In some examples, a bus 351 may include a same quantity of signal paths as a bus 341 (e.g., for signaling GIO[287:0]). In some examples, a bus 351 may include a same quantity of signal paths as a quantity of columns in each memory array 250. In some other examples, the memory arrays 250 may include a quantity of columns that is an integer multiple of the quantity of signal paths of a bus 351, in which case the memory array circuitry (e.g., each memory array 250) may include decoding circuitry operable to couple a subset of columns of memory cells, or associated circuitry, with the bus 351.

To support write operations, the write/sense circuitry 350 may be configured to drive signaling (e.g., over the bus 351) that is operable to write one or more logic states to memory cells of the memory arrays 250 (e.g., based on data received over a bus 341, based on timing signaling received over a bus 371, based on data signaling received over a bus 303 and on control signaling received over a bus 301). In some examples, such signaling may be transmitted to supporting circuitry of or otherwise associated with the memory arrays 250 (e.g., as an output of signals corresponding to logic states to be written), such as sense amplifier circuitry, voltage sources, current sources, or other driver circuitry operable to apply a bias across a storage element of the memory cells (e.g., across a capacitor, across a ferroelectric capacitor), or apply a charge, a current, or other signaling to a storage element of the memory cells (e.g., to apply a current to a chalcogenide or other configurable memory material, to apply a charge to a gate of a NAND memory cell), among other examples.

To support read operations, the write/sense circuitry 350 may be configured to receive signaling (e.g., over the bus 351) that the write/sense circuitry 350 may further amplify for communication through the interface block 260-b. For example, the write/sense circuitry 350 may be configured to receive signaling corresponding to logic states read from the memory arrays 250, but at a relatively low driver strength (e.g., relatively ‘analog’ signaling, which may be associated with a relatively low drive strength of sense amplifiers of the memory arrays 250). The write/sense circuitry 350 may thus include further sense amplification (e.g., a data sense amplifier (DSA) between each signal path of the bus 351 and a respective signal path of the bus 341), which each may have a relatively high drive strength (e.g., for driving relatively digital signaling over the bus 341).

The features of the interface architecture 300 may be duplicated in various quantities and arrangements to support a semiconductor system having multiple dies, such as various examples of a system 200. In an example implementation, each die 240 may be configured with 64 instances of the interface block 260-b, which may support a data signaling width of 9,216 signal paths for each die 240 (e.g., where each bus 303 of a channel pair is associated with 72 signal paths). For a system 200 having a stack of eight dies 240 coupled with a die 205, the die 205 may thus be configured with 512 instances of the interface block 220-b, thereby supporting an overall data signaling width of 73,738 signal paths for the system 200. However, in other implementations, dies 205 and dies 240 may be configured with different quantities of interface blocks 220 and 260, respectively, and a system 200 may be configured with different quantities of dies 240 per die 205. By dividing memory access circuitry among multiple semiconductor dies (e.g., a die 205 and one or more dies 240) in accordance with one or more of the described techniques, a system 200 may thus be configured with an increased throughput of information, or a greater storage density, among other advantages, compared with other techniques for configuring a memory system.

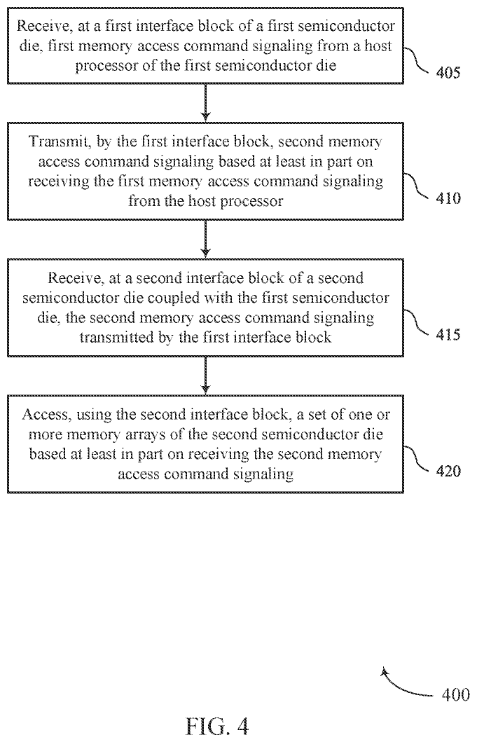

FIG. 4 illustrates a flowchart showing a method 400 that supports techniques for coupled host and memory dies in accordance with examples as disclosed herein. The operations of method 400 may be implemented by a semiconductor system or its components as described herein (e.g., with reference to FIGS. 1 through 3). In some examples, a semiconductor system may execute a set of instructions to control the functional elements of the device to perform the described functions. Additionally, or alternatively, the semiconductor system may perform aspects of the described functions using special-purpose circuitry.

At 405, the method 400 may include receiving, at a first interface block of a first semiconductor die, first memory access command signaling from a host processor of the first semiconductor die.

At 410, the method 400 may include transmitting, by the first interface block, second memory access command signaling based at least in part on receiving the first memory access command signaling from the host processor.

At 415, the method 400 may include receiving, at a second interface block of a second semiconductor die coupled with the first semiconductor die, the second memory access command signaling transmitted by the first interface block.

At 420, the method 400 may include accessing, using the second interface block, a set of one or more memory arrays of the second semiconductor die based at least in part on receiving the second memory access command signaling.

In some examples, an apparatus as described herein may be configured to perform a method or methods, such as the method 400. The apparatus may include features (e.g., circuitry, logic, one or more controllers, or other means), instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, or instructions, or any combination thereof for: receiving, at a first interface block of a first semiconductor die, first memory access command signaling from a host processor of the first semiconductor die; transmitting, by the first interface block, second memory access command signaling based at least in part on receiving the first memory access command signaling from the host processor: receiving, at a second interface block of a second semiconductor die coupled with the first semiconductor die, the second memory access command signaling transmitted by the first interface block; and accessing, using the second interface block, a set of one or more memory arrays of the second semiconductor die based at least in part on receiving the second memory access command signaling.

Aspect 2: The method, apparatus, or non-transitory computer-readable medium of aspect 1, further including operations, features, or instructions, or any combination thereof for receiving, from the host processor at the first interface block, first data signaling associated with the first memory access command signaling; transmitting, from the first interface block, second data signaling associated with the second memory access command signaling based at least in part on the received first memory access command signaling and the received first data signaling; receiving, at the second interface block, the second data signaling: and writing data, using the second interface block, to the set of one or more memory arrays based at least in part on the received second memory access command signaling and the received second data signaling.

Aspect 3: The method, apparatus, or non-transitory computer-readable medium of any of aspects 1 through 2, further including operations, features, or instructions, or any combination thereof for: reading data from the set of one or more memory arrays, using the second interface block, based at least in part on the received second memory access command signaling: transmitting, from the second interface block, first data signaling based at least in part on the read data: receiving, at the first interface block, the first data signaling; and transmitting, from the first interface block to the host processor, second data signaling based at least in part on the received first data signaling.

Aspect 4: The method, apparatus, or non-transitory computer-readable medium of any of aspects 1 through 3, further including operations, features, or instructions, or any combination thereof for: generating, at the first interface block, the second memory access command signaling based at least in part on a detected error associated with a physical address of the set of one or more memory arrays.

Aspect 5: The method, apparatus, or non-transitory computer-readable medium of any of aspects 1 through 4, further including operations, features, or instructions, or any combination thereof for: receiving, at the first interface block, an indication of an operating temperature and generating, at the first interface block, the second memory access command signaling based at least in part on the received indication of the operating temperature.

Aspect 6: The method, apparatus, or non-transitory computer-readable medium of any of aspects 1 through 5, further including operations, features, or instructions, or any combination thereof for: determining, at the first interface block based at least in part on the received first memory access command signaling, that a rate of accessing one or more physical addresses of the set of memory arrays satisfies a threshold and generating, at the first interface block, the second memory access command signaling based at least in part on determining that the rate of accessing satisfies the threshold.

Aspect 7: The method, apparatus, or non-transitory computer-readable medium of any of aspects 1 through 6, further including operations, features, or instructions, or any combination thereof for: transmitting, by the first interface block, first clock signaling to the second interface block: receiving, at the first interface block, second clock signaling from the second interface block based at least in part on transmitting the first clock signaling: and modifying, at the first interface block, a timing of the first clock signaling based at least in part on the received second clock signaling.

Aspect 8: The method, apparatus, or non-transitory computer-readable medium of any of aspects 1 through 7, further including operations, features, or instructions, or any combination thereof for: transmitting, by the first interface block, first clock signaling to the second interface block; receiving, at the first interface block, second clock signaling from the second interface block based at least in part on transmitting the first clock signaling: and transmitting, by the first interface block, an indication to the second interface block to modify a timing of the second clock signaling based at least in part on the received second clock signaling.

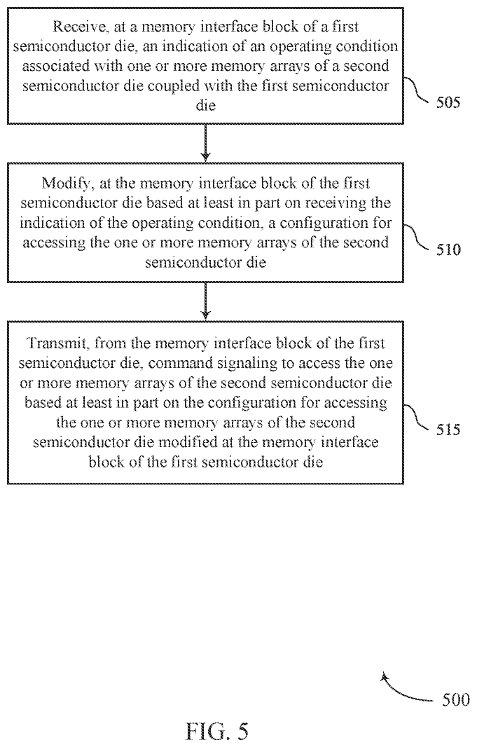

FIG. 5 illustrates a flowchart showing a method 500 that supports techniques for coupled host and memory dies in accordance with examples as disclosed herein. The operations of method 500 may be implemented by a semiconductor system or its components as described herein (e.g., with reference to FIGS. 1 through 3). In some examples, a semiconductor system may execute a set of instructions to control the functional elements of the device to perform the described functions. Additionally, or alternatively, the semiconductor system may perform aspects of the described functions using special-purpose hardware.

At 505, the method may include receiving, at a memory interface block of a first semiconductor die, an indication of an operating condition associated with one or more memory arrays of a second semiconductor die coupled with the first semiconductor die.

At 510, the method may include modifying, at the memory interface block of the first semiconductor die based at least in part on receiving the indication of the operating condition, a configuration for accessing the one or more memory arrays of the second semiconductor die.

At 515, the method may include transmitting, from the memory interface block of the first semiconductor die, command signaling to access the one or more memory arrays of the second semiconductor die based at least in part on the configuration for accessing the one or more memory arrays of the second semiconductor die modified at the memory interface block of the first semiconductor die.

In some examples, an apparatus as described herein may perform a method or methods, such as the method 500. The apparatus may include features (e.g., circuitry, logic, one or more controllers, or other means), or instructions (e.g., a non-transitory computer-readable medium storing instructions executable by a processor), or any combination thereof for performing the following aspects of the present disclosure:

Aspect 9: A method, apparatus, or non-transitory computer-readable medium including operations, features, or instructions, or any combination thereof for: receiving, at a memory interface block of a first semiconductor die, an indication of an operating condition associated with one or more memory arrays of a second semiconductor die coupled with the first semiconductor die: modifying, at the memory interface block of the first semiconductor die based at least in part on receiving the indication of the operating condition, a configuration for accessing the one or more memory arrays of the second semiconductor die: and transmitting, from the memory interface block of the first semiconductor die, command signaling to access the one or more memory arrays of the second semiconductor die based at least in part on the configuration for accessing the one or more memory arrays of the second semiconductor die modified at the memory interface block of the first semiconductor die.

Aspect 10: The method, apparatus, or non-transitory computer-readable medium of aspect 9, further including operations, features, or instructions, or any combination thereof for: receiving, at the memory interface block of the first semiconductor die, an indication of a temperature associated with operating the one or more memory arrays of the second semiconductor die; and modifying the configuration for accessing the one or more memory arrays of the second semiconductor die based at least in part on the received indication of the temperature.

Aspect 11: The method, apparatus, or non-transitory computer-readable medium of any of aspects 9 through 10, further including operations, features, or instructions, or any combination thereof for: receiving, at the memory interface block of the first semiconductor die, an indication of an error associated with a physical address of the one or more memory arrays of the second semiconductor die: and modifying the configuration for accessing the one or more memory arrays of the second semiconductor die based at least in part on the received indication of the error associated with the physical address.

Aspect 12: The method, apparatus, or non-transitory computer-readable medium of any of aspects 9 through 11, further including operations, features, or instructions, or any combination thereof for: receiving, at the memory interface block of the first semiconductor die, an indication to perform an evaluation of operations for accessing the one or more memory arrays of the second semiconductor die: and modifying the configuration for accessing the one or more memory arrays of the second semiconductor die based at least in part on the received indication to perform an evaluation of operations for accessing the one or more memory arrays of the second semiconductor die.

It should be noted that the methods described herein describe possible implementations, and that the operations and the steps may be rearranged or otherwise modified and that other implementations are possible. Further, portions from two or more of the methods may be combined.

An apparatus is described. The following provides an overview of aspects of the apparatus as described herein:

Aspect 13: An apparatus, including: a first semiconductor die, including: a host processor; and a plurality of first interface blocks, each first interface block of the plurality of first interface blocks including respective first circuitry configured to receive first access command signaling from the host processor and to transmit second access command signaling based at least in part on the received first access command signaling: and one or more second semiconductor dies coupled with the first semiconductor die, the one or more second semiconductor dies including: a plurality of memory arrays; and a plurality of second interface blocks, each second interface block of the plurality of second interface blocks coupled with a respective first interface block of the plurality of first interface blocks and including respective second circuitry configured to receive the second access command signaling from the respective first interface block and to access a respective set of one or more memory arrays of the plurality of memory arrays based at least in part on the received second access command signaling.

Aspect 14: The apparatus of aspect 13, where at least one second interface block of the plurality of second interface blocks is coupled with the respective first interface block via a command interface associated with first clock signaling, and via a data interface associated with second clock signaling.

Aspect 15: The apparatus of aspect 14, where at least one second interface block of the plurality of second interface blocks is coupled with the respective first interface block via a second data interface associated with third clock signaling.

Aspect 16: The apparatus of any of aspects 13 through 15, where the one or more second semiconductor dies include: a first die coupled with the first semiconductor die and including a first subset of the plurality of memory arrays and a first subset of the plurality of second interface blocks; and a second die coupled with the first die and including a second subset of the plurality of memory arrays and a second subset of the plurality of second interface blocks, where each second interface block of the plurality of second interface blocks is coupled with the respective first interface block via a respective set of one or more conductive paths through the first die.

Aspect 17: The apparatus of any of aspects 13 through 16, where at least one first interface block of the plurality of first interface blocks includes circuitry configured to: generate the second access command signaling based at least in part on a detected error associated with a physical address of the plurality of memory arrays.

Aspect 18: The apparatus of aspect 17, where the circuitry configured to generate the second access command signaling is configured to: generate an address of a second row of memory cells based at least in part on detecting the error associated with a first row of memory cells.

Aspect 19: The apparatus of any of aspects 17 through 18, where the circuitry configured to generate the second access command signaling is configured to: generate an address of a second column of memory cells based at least in part on detecting the error associated with a first column of memory cells.

Aspect 20: The apparatus of any of aspects 13 through 19, where at least one first interface block of the plurality of first interface blocks includes circuitry configured to: receive an indication of an operating temperature of the apparatus; and generate the second access command signaling based at least in part on the received indication of the operating temperature.

Aspect 21: The apparatus of any of aspects 13 through 20, where at least one first interface block of the plurality of first interface blocks includes circuitry configured to: determine, based at least in part on the received first access command signaling, that a rate of accessing one or more physical addresses of the plurality of memory arrays satisfies a threshold; and generate the second access command signaling based at least in part on determining that the rate of accessing satisfies the threshold.

Aspect 22: The apparatus of any of aspects 13 through 21, where at least one first interface block of the plurality of first interface blocks includes circuitry configured to: receive an indication to perform an evaluation of the respective second interface block, of the respective set of memory arrays that the respective second interface block is configured to access, or a combination thereof: and transmit command signaling, data signaling, or both to the respective second interface block based at least in part on the received indication to perform the evaluation.

Aspect 23: The apparatus of any of aspects 13 through 22, where at least one first interface block of the plurality of first interface blocks includes circuitry configured to: determine a rate for refreshing memory cells of the respective set of memory arrays that the respective second interface block is configured to access: and transmit command signaling to the respective second interface block based at least in part on the determined rate for refreshing memory cells.

Aspect 24: The apparatus of any of aspects 13 through 23, where: at least one first interface block of the plurality of first interface blocks is configured to transmit first clock signaling to the respective second interface block; and at least one other first interface block of the plurality of first interface blocks is configured to transmit second clock signaling to the respective second interface block with a timing that is offset relative to the first clock signaling.

Aspect 25: The apparatus of any of aspects 13 through 24, where at least one first interface block of the plurality of first interface blocks includes circuitry configured to: transmit first clock signaling to the respective second interface block; receive second clock signaling from the respective second interface block based at least in part on transmitting the first clock signaling; and modifying a timing of the first clock signaling based at least in part on the received second clock signaling.

Aspect 26: The apparatus of any of aspects 13 through 25, where at least one first interface block of the plurality of first interface blocks includes circuitry configured to: transmit first clock signaling to the respective second interface block: receive second clock signaling from the respective second interface block based at least in part on transmitting the first clock signaling; and transmit an indication to the respective second interface block to modify a timing of the second clock signaling based at least in part on the received second clock signaling.

Aspect 27: The apparatus of any of aspects 13 through 26, where: each first interface block of the plurality of first interface blocks is configured to receive first data signaling associated with the first access command signaling and to transmit second data signaling associated with the second access command signaling based at least in part on the received first access command signaling and the received first data signaling; and each second interface block of the plurality of second interface blocks is configured to receive the second data signaling and to write data to the respective set of one or more memory arrays based at least in part on the received second access command signaling and the received second data signaling.

Aspect 28: The apparatus of aspect 27, where each first interface block of the plurality of first interface blocks includes circuitry configured to: generate the second data signaling based at least in part on performing an error control operation using the received first data signaling.

Aspect 29: The apparatus of any of aspects 13 through 28, where: each second interface block of the plurality of second interface blocks is configured to read data from the respective set of one or more memory arrays based at least in part on the received second access command signaling and to transmit first data signaling based at least in part on the read data: and each first interface block of the plurality of first interface blocks is configured to receive the first data signaling and to transmit second data signaling based at least in part on the received first data signaling.

Aspect 30: The apparatus of aspect 29, where at least one first interface block of the plurality of first interface blocks includes circuitry configured to: generate the second data signaling based at least in part on performing an error control operation using the received first data signaling.

Aspect 31: The apparatus of any of aspects 13 through 30, where at least one second interface block of the plurality of second interface blocks includes: a first bus configured to communicate first data signaling with the respective set of one or more memory arrays via a first quantity of signal paths: a second bus configured to communicate second data signaling with the respective first interface block via a second quantity of signal paths; and a serializer/deserializer configured for converting between the first data signaling via the first quantity of signal paths and the second data signaling via the second quantity of signal paths.

Aspect 32: The apparatus of any of aspects 13 through 31, where at least one second interface block of the plurality of second interface blocks is coupled with the respective first interface block via one or more respective first conductor portions at a surface of the first semiconductor die that are fused with one or more respective second conductor portions at a surface of a second semiconductor die of the one or more semiconductor dies.

An apparatus is described. The following provides an overview of aspects of the apparatus as described herein:

Aspect 33: An apparatus including circuitry configured to: receive, at a first interface block of a first semiconductor die, first memory access command signaling from a host processor of the first semiconductor die; transmit, by the first interface block, second memory access command signaling based at least in part on receiving the first memory access command signaling from the host processor: receive, at a second interface block of a second semiconductor die coupled with the first semiconductor die, the second memory access command signaling transmitted by the first interface block; and access, using the second interface block, a set of one or more memory arrays of the second semiconductor die based at least in part on receiving the second memory access command signaling.

An apparatus is described. The following provides an overview of aspects of the apparatus as described herein:

Aspect 34: An apparatus including circuitry configured to: receive, at a memory interface block of a first semiconductor die, an indication of an operating condition associated with one or more memory arrays of a second semiconductor die coupled with the first semiconductor die: modify, at the memory interface block of the first semiconductor die based at least in part on receiving the indication of the operating condition, a configuration for accessing the one or more memory arrays of the second semiconductor die; and transmit, from the memory interface block of the first semiconductor die, command signaling to access the one or more memory arrays of the second semiconductor die based at least in part on the modified configuration for accessing the one or more memory arrays of the second semiconductor die.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact.” “connected.” and “coupled” may refer to a relationship between components that supports the flow of signals between the components. Components are considered in electronic communication with (e.g., in conductive contact with, connected with, coupled with) one another if there is any electrical path (e.g., conductive path) between the components that can, at any time, support the flow of signals (e.g., charge, current, voltage) between the components. At any given time, a conductive path between components that are in electronic communication with each other (e.g., in conductive contact with, connected with, coupled with) may be an open circuit or a closed circuit based on the operation of the device that includes the connected components. A conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The description set forth herein, in connection with the appended drawings, describes example configurations and does not represent all the examples that may be implemented or that are within the scope of the claims. The term “exemplary” used herein means “serving as an example, instance, or illustration.” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. An apparatus, comprising:
a first semiconductor die, comprising:
a host processor; and
a plurality of first interface blocks, each first interface block of the plurality of first interface blocks comprising respective first circuitry configured to receive first access command signaling from the host processor and to transmit second access command signaling based at least in part on the received first access command signaling; and
one or more second semiconductor dies coupled with the first semiconductor die, the one or more second semiconductor dies comprising:
a plurality of memory arrays; and
a plurality of second interface blocks, each second interface block of the plurality of second interface blocks coupled with a respective first interface block of the plurality of first interface blocks and comprising respective second circuitry configured to receive the second access command signaling from the respective first interface block and to access a respective set of one or more memory arrays of the plurality of memory arrays based at least in part on the received second access command signaling.

2. The apparatus of claim 1, wherein at least one second interface block of the plurality of second interface blocks is coupled with the respective first interface block via a command interface associated with first clock signaling, and via a data interface associated with second clock signaling.

3. The apparatus of claim 2, wherein at least one second interface block of the plurality of second interface blocks is coupled with the respective first interface block via a second data interface associated with third clock signaling.

4. The apparatus of claim 1, wherein the one or more second semiconductor dies comprise:
a first die coupled with the first semiconductor die and comprising a first subset of the plurality of memory arrays and a first subset of the plurality of second interface blocks; and
a second die coupled with the first die and comprising a second subset of the plurality of memory arrays and a second subset of the plurality of second interface blocks, wherein each second interface block of the plurality of second interface blocks is coupled with the respective first interface block via a respective set of one or more conductive paths through the first die.

5. The apparatus of claim 1, wherein at least one first interface block of the plurality of first interface blocks comprises circuitry configured to:
generate the second access command signaling based at least in part on a detected error associated with a physical address of the plurality of memory arrays.

6. The apparatus of claim 1, wherein at least one first interface block of the plurality of first interface blocks comprises circuitry configured to:
receive an indication of an operating temperature of the apparatus; and
generate the second access command signaling based at least in part on the received indication of the operating temperature.

7. The apparatus of claim 1, wherein at least one first interface block of the plurality of first interface blocks comprises circuitry configured to:
determine, based at least in part on the received first access command signaling, that a rate of accessing one or more physical addresses of the plurality of memory arrays satisfies a threshold; and
generate the second access command signaling based at least in part on determining that the rate of accessing satisfies the threshold.

8. The apparatus of claim 1, wherein at least one first interface block of the plurality of first interface blocks comprises circuitry configured to:
receive an indication to perform an evaluation of the respective second interface block, of the respective set of memory arrays that the respective second interface block is configured to access, or a combination thereof; and
transmit command signaling, data signaling, or both to the respective second interface block based at least in part on the received indication to perform the evaluation.

9. The apparatus of claim 1, wherein at least one first interface block of the plurality of first interface blocks comprises circuitry configured to:
determine a rate for refreshing memory cells of the respective set of memory arrays that the respective second interface block is configured to access; and
transmit command signaling to the respective second interface block based at least in part on the determined rate for refreshing memory cells.

10. The apparatus of claim 1, wherein:
at least one first interface block of the plurality of first interface blocks is configured to transmit first clock signaling to the respective second interface block; and
at least one other first interface block of the plurality of first interface blocks is configured to transmit second clock signaling to the respective second interface block with a timing that is offset relative to the first clock signaling.

11. The apparatus of claim 1, wherein:
each first interface block of the plurality of first interface blocks is configured to receive first data signaling associated with the first access command signaling and to transmit second data signaling associated with the second access command signaling based at least in part on the received first access command signaling and the received first data signaling; and
each second interface block of the plurality of second interface blocks is configured to receive the second data signaling and to write data to the respective set of one or more memory arrays based at least in part on the received second access command signaling and the received second data signaling.

12. The apparatus of claim 1, wherein:
each second interface block of the plurality of second interface blocks is configured to read data from the respective set of one or more memory arrays based at least in part on the received second access command signaling and to transmit first data signaling based at least in part on the read data; and
each first interface block of the plurality of first interface blocks is configured to receive the first data signaling and to transmit second data signaling based at least in part on the received first data signaling.

13. A method, comprising:
receiving, at a first interface block of a first semiconductor die, first memory access command signaling from a host processor of the first semiconductor die;
transmitting, by the first interface block, second memory access command signaling based at least in part on receiving the first memory access command signaling from the host processor;
receiving, at a second interface block of a second semiconductor die coupled with the first semiconductor die, the second memory access command signaling transmitted by the first interface block; and
accessing, using the second interface block, a set of one or more memory arrays of the second semiconductor die based at least in part on receiving the second memory access command signaling.

14. The method of claim 13, further comprising:
receiving, from the host processor at the first interface block, first data signaling associated with the first memory access command signaling:
transmitting, from the first interface block, second data signaling associated with the second memory access command signaling based at least in part on the received first memory access command signaling and the received first data signaling;
receiving, at the second interface block, the second data signaling; and
writing data, using the second interface block, to the set of one or more memory arrays based at least in part on the received second memory access command signaling and the received second data signaling.

15. The method of claim 13, further comprising:
reading data from the set of one or more memory arrays, using the second interface block, based at least in part on the received second memory access command signaling;
transmitting, from the second interface block, first data signaling based at least in part on the read data;
receiving, at the first interface block, the first data signaling; and
transmitting, from the first interface block to the host processor, second data signaling based at least in part on the received first data signaling.

16. The method of claim 13, further comprising:
generating, at the first interface block, the second memory access command signaling based at least in part on a detected error associated with a physical address of the set of one or more memory arrays.

17. The method of claim 13, further comprising:
receiving, at the first interface block, an indication of an operating temperature; and
generating, at the first interface block, the second memory access command signaling based at least in part on the received indication of the operating temperature.

18. An apparatus comprising circuitry configured to:
receive, at a first interface block of a first semiconductor die, first memory access command signaling from a host processor of the first semiconductor die;
transmit, by the first interface block, second memory access command signaling based at least in part on receiving the first memory access command signaling from the host processor;
receive, at a second interface block of a second semiconductor die coupled with the first semiconductor die, the second memory access command signaling transmitted by the first interface block; and
access, using the second interface block, a set of one or more memory arrays of the second semiconductor die based at least in part on receiving the second memory access command signaling.

19. The apparatus of claim 18, further comprising circuitry configured to:
receiving, from the host processor at the first interface block, first data signaling associated with the first memory access command signaling:
transmitting, from the first interface block, second data signaling associated with the second memory access command signaling based at least in part on the received first memory access command signaling and the received first data signaling;
receiving, at the second interface block, the second data signaling; and
writing data, using the second interface block, to the set of one or more memory arrays based at least in part on the received second memory access command signaling and the received second data signaling.

20. The apparatus of claim 18, further comprising circuitry configured to:
reading data from the set of one or more memory arrays, using the second interface block, based at least in part on the received second memory access command signaling;
transmitting, from the second interface block, first data signaling based at least in part on the read data;
receiving, at the first interface block, the first data signaling; and
transmitting, from the first interface block to the host processor, second data signaling based at least in part on the received first data signaling.
